(19) United States
(12) Patent Application Publication
(10) Pub. No.: US 2013/0007478 A1
(43) Pub. Date: Jan. 3, 2013

(54) TESTING SYSTEM FOR BACKUP BATTERY MODULE OF STORING SYSTEM

(75) Inventor: CHING-FU LIN, Tu-Cheng (TW)

(73) Assignee: HON HAI PRECISION INDUSTRY CO., LTD., Tu-Cheng (TW)

(21) Appl. No.: 13/246,874

(22) Filed: Sep. 28, 2011

(30) Foreign Application Priority Data
Jun. 30, 2011 (TW) 100123071

(51) Int. Cl. G06F 1/26

(52) U.S. Cl. 713/300

(57) ABSTRACT

A storing system is connected between an external power supply module and a server. The server is connected to external power supply module. The server switches off the external power supply module with the power source when the measured batch file is wholly transmitted to the first storing module. The backup battery module supplies power to the first storing module. The server compares the files stored in the permanent storing module with the measured batch file to determine whether or not the backup battery module is in working order.

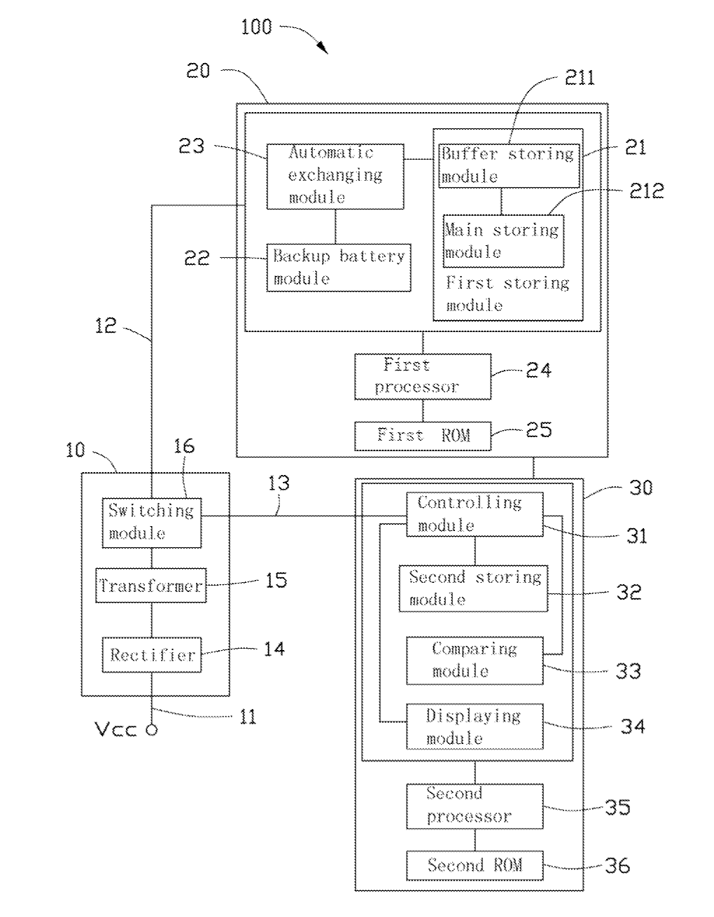

### BACKGROUND

1. Technical Field

The present disclosure relates to testing systems, and particularly, to a testing system for a backup battery module of a storing system.

2. Description of Related Art

Storing system devices include a storing module and a backup battery module. The storing module includes a buffer and a permanent storing module. In use, files are first temporarily stored in the buffer and then transmitted to the permanent storing module. The backup battery module supplies power to the storing module in case of power failure of an external power source connected to the storing module and, therefore, the transmittance of files from the buffer to the permanent storing module can be finished. Clearly, the transmittance of files may still fail if the backup battery module does not work. However, because the backup battery module is integrated in the storing system, it is difficult for users to recognize whether or not the backup battery module is working properly.

Therefore, it is desirable to provide a testing system, which can overcome the limitations described.

### BRIEF DESCRIPTION OF THE DRAWING

The FIGURE is a function block of a testing system in accordance with an exemplary embodiment.

### DETAILED DESCRIPTION

Embodiments of the disclosure will now be described in detail, with reference to the accompanying drawing.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash storing system, and hard disk drives.

Referring to the drawing, a testing system 100, according to an exemplary embodiment, includes an external power supply module 10, a storing system 20, and a server 30.

The external power supply module 10 includes an input terminal 11, an output terminal 12, and a control terminal 13. The input terminal 11 is connected to an external power source Vcc. The output terminal 12 is connected to the storing system 20. The control terminal 13 is connected to the server 30. The external power supply module 10 supplies power to the storing system 20.

The external power supply module 10 includes a rectifier 14, a transformer 15, and a switching module 16. The transformer 15 is connected between the rectifier 14 and the switching module 16. The rectifier 14 is connected to the input terminal 11. The switching module 16 is connected to the output terminal 12 and the control terminal 13. The rectifier 14 is an electrical device that converts alternating current (AC), which periodically reverses direction, to direct current (DC) which flows in only one direction. The transformer 15 is an electrical device that transfers electrical energy from one circuit to another through inductively coupled conductors. The switching module 16 is a switch that connects or disconnects the input terminal 11 and the output terminal 12 based upon a control signal sent to the control terminal 13.

The external power supply module 10 has a preset response time. When the control terminal 13 receives the control signal, the switching module 16 is switched off after the preset response time, and then the input terminal 11 and the output terminal 12 are disconnected. In one embodiment, when the control signal is a lower level voltage, such as 0 volts(V), the switching module 16 is switched on, and the input terminal 11 connects to the output terminal 12. When the control signal is a high level voltage, such as 5V, the switching module 16 is switched off, and the input terminal 11 disconnects from the output terminal 12.

The storing system 20 includes a first storing module 21, a backup battery module 22, an automatic exchanging module 23, a first processor 24, and a first read only memory (ROM) 25. One or more software codes of the modules 21-23 are stored in the first ROM 25 and executed by the first processor 24. The automatic exchanging module 23 is connected to the first storing module 21, the backup battery module 22, and the output terminal 12 of the external power supply module 10, is switchable and connects to the external power supply module 10 and the backup battery module 22. When the switching module 16 of the external power supply module 10 is switched on, the automatic exchanging module 23 is electrically connected to the external power supply module 10. When the switching module 16 of the external power supply module 10 is switched off, the automatic exchanging module 23 is electrically connected to the backup battery module 22.

The first storing module 21 includes a buffer 211 and a permanent storing module 212 connected to the buffer 211. During the process of storing files, such as images, the files are first temporarily stored in the buffer 211, and then the files stored in the buffer 211 are written into the permanent storing module 212. If the files stored in the buffer 211 are not immediately written into the permanent storing module 212, the files stored in the buffer 211 can be lost in the case of a power failure. In one embodiment, the storing system 20 is a hard disk or a USB drive.

The server 30 includes a control module 31, a second storing module 32, a comparing module 33, a display module 34, a second processor 35, and a second ROM 36. One or more software codes of the modules 31-33 are stored in the second ROM 36 and executed by the second processor 35. The control module 31 is connected to the second storing module 32, the comparing module 33, and the display module 34. The control module 31 is further connected to the control terminal 13 of the switching module 16 via a LAN, SUB, or RS232, and is connected to the first storing module 21 via a fiber, SAS, or iSCSI.

A measured batch file is stored in the second storing module 32, and a labeled file is set in the measured batch file. The measured batch file contains a number of files, and the labeled file is one of the files of the measured batch file. The size of the measured batch file can be 5 megabytes (MBs) in one example. During the process of transmitting the measured batch file from the second storing module 32 to the first storing module 21, the control module 31 outputs the control signal when the labeled file is transmitted to the first storing module 21. The comparing module 33 compares the files stored in the permanent storing module 212 with the measured batch file, and decides whether the stored files are the same as the measured batch file. The displaying module 34 displays a result of the comparison. In one embodiment, if the result shows that the stored files are the same as the measured batch file, the displaying module 34 displays “1”, and if the result shows that the stored files are different from the measured batch file, the displaying module 34 displays “0”.

During testing of the backup battery module 22, firstly, the server 30 outputs a control signal with a low level voltage, such as 0v, to the switching module 16 via the control terminal 13. This causes the switching module 16 to be switched on, and the input terminal 11 to be connected to the output terminal 12. The automatic exchanging module 23 is electrically connected to the external power supply module 10, and the first storing module 21 is powered with the external power supply module 10. The external power supply module 10 charges the backup battery module 22 at the same time as the first storing module 21.

Secondly, the control module 31 acquires the measured batch file from the second storing module 32, and transmits the measured batch file to the first storing module 21. During the process of transmitting the batch file from the second storing module 32 to the first storing module 21, the control module 31 outputs the control signal with a high level voltage, such as +5v, after the labeled file is transmitted to the first storing module. When the measured batch file is wholly transmitted to the first storing module 21, the input terminal 11 and the output terminal 12 of the external power supply module 10 are disconnected after the preset response time. At this moment, part of the measured batch file is stored in the buffer 211 and the other part of the measured batch file is stored in the permanent storing module 212. The automatic exchanging module 23 is electrically connected to the backup battery module 22 immediately after the input terminal 11 is disconnected from the output terminal 12. The first storing module 21 is powered by the backup battery module 22. The part of the measured batch file that is stored in the buffer 211 is wholly written into the permanent storing module 212.

Thirdly, after a determined time delay, the comparing module 33 acquires size of files stored in the permanent storing module 212 and size of the measured batch file initially stored in the second storing module 32. The comparing module 33 compares the size of the files stored in the permanent storing module 212 with the size of the measured batch file previously stored in the second storing module 32. The comparing module 33 determines whether or not the files are the same as the measured batch file according to the comparing result. If the size of the files stored in the permanent storing module 212 is 5 MBs, and indicating the backup battery module 22 is in working order. The display module 34 displays “1”. If the size of the files stored in the permanent storing module 212 is less than 5 MBs, indicating the backup battery module 22 is not in working order. The display module 34 displays “0”.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A storing system connected between an external power supply module and a server, and comprising:
a first processor;
a first read only memory (ROM) storing one or more modules that are executed by the first processor, the one or more modules comprising:
a first storing module comprising a buffer and a permanent storing module connected to the buffer, and powered by the external power supply module; and
a backup battery module that supplies power to the first storing module when the external power supply module is switched off by the server;
wherein the first storing module receives a measured batch file from the server, the external power supply module is switched off when the measured batch file is wholly transmitted to the first storing module; after a determined time delay, the files stored in the permanent storing module is compared with the measured batch file to determine whether or not the backup battery module is in working order.

2. The storing system of claim 1, wherein the switching module receives a control signal from the server to disconnect the input terminal and the output terminal when the measured batch file is wholly transmitted from the second storing module to the first storing module.

3. The storing system of claim 2, wherein a labeled file is set in the measured batch file, and the control module outputs the control signal after the labeled file is transmitted to the first storing module, the measured batch file transmits the first storing module after a preset response time.

4. The storing system of claim 1, wherein the backup battery module is charged by the external power supply module.

5. The storing system of claim 1, further comprising an automatic exchanging module connected to the first storing module, the backup battery module, and the external power supply module.

6. The storing system of claim 5, wherein when the external power supply module is switched on, the automatic exchanging module is electrically connected to the external power supply module, when the external power supply module is switched off, the automatic exchanging module is electrically connected to the backup battery module.

7. The storing system of claim 1, wherein if the size of the files stored in the permanent storing module is the same as the measured batch file, and indicating the backup battery module is in working order; otherwise, the backup battery module is not in working order.

8. The storing system of claim 1, wherein the measured file transmitted to the first storing module is first temporarily stored in the buffer and then transmitted to the permanent storing module.

9. The storing system of claim 8, wherein when the external power supply module is switched off, part of the measured batch file is stored in the buffer and the other part of the measured batch file is stored in the permanent storing module.
